(19) United States
(12) Patent Application Publication
(10) Pub. No.: US 2017/0277838 A1
(43) Pub. Date: Sep. 28, 2017

(54) CRITERIA TEMPLATE AUTO-GENERATION AND CRITERIA AUTO-POPULATION

(71) Applicant: Experian Health, Inc., Franklin, TN (US)

(72) Inventor: Richard Frank Derer, Westmont, IL (US)

(73) Assignee: Experian Health, Inc., Franklin, TN (US)

(21) Appl. No.: 15/081,589

(22) Filed: Mar. 25, 2016

(51) Int. Cl. G06F 19/00; G06Q 50/18; G06F 17/24

(52) U.S. Cl. CPC G06F 19/328; G06F 17/248; G06Q 50/18

(57) ABSTRACT

Automated criteria template generation and automated criteria population in a contract model for improving the efficiency, functionality, and accuracy of systems for contract modeling and claim valuation are provided. When modeling contracts for claim valuation, terms are entered into a contract model, and criteria are entered that determine whether a particular term matches an item on a claim. A contract modeling and claim valuation system collects and stores criteria data that have matched service terms during claim valuations, and prioritizes the criteria for building criteria templates for associated service terms. When a contract model is being built, and entry of a particular service term is received, the contract modeler searches for criteria templates that are associated with the service term. A criteria template is selected, and the criteria in the criteria template are automatically loaded into a criteria section of the contract modeler graphical user interface.

### BACKGROUND

When a patient receives healthcare services from a healthcare provider, payments for the services are typically paid by a third party payer, such as a social insurance program, a social welfare program, or a private insurance company. Most often, the healthcare provider has a managed care contract with the third party payer that defines how the provider will be reimbursed by the payer, which may be a negotiated discount off charge master prices, a set amount, or other negotiated amount. A given healthcare provider may have managed care contracts with a large number of third party payers, wherein each payer may pay different amounts for a procedure or service based on the contract it has with the provider.

To simulate how a payer should reimburse a healthcare provider for services rendered, the healthcare provider or an intermediary system associated with the healthcare provider may model managed care contracts, and use the model contracts to valuate claims. When modeling contracts, a contract analyst enters service terms and criteria data that are used by a claim valuator to determine whether a particular service term matches an item on a claim. Some managed care contracts supply the criteria, but oftentimes not for every service term. When criteria data are not supplied, the contract analyst has to manually enter criteria data. Oftentimes, the contract analyst has to make a best guess based on experience, or rely on extensive coding manuals, which become outdated and are revised annually. As can be appreciated, manually entering data is labor-intensive, time-consuming and inefficient, and is prone to human error, particularly when modeling a large number of contracts.

It is with respect to these and other considerations that the present invention has been made.

### BRIEF SUMMARY

The present disclosure provides systems and methods for improving the efficiency, functionality, and accuracy of systems for contract modeling and claim valuation. A claim is valuated by a claim valuator for determining an expected reimbursement for the claim by matching billed items in the claim against criteria in a managed care contract to determine whether a particular term matches the billed item in the claim. Results of the claim valuation are stored and used for building criteria templates.

Criteria templates are built by reading the criteria associated with the terms that have matched various services during claim valuations. When a given service term has been satisfied with more than one set of criteria, the sets of criteria may be prioritized based on frequency or on another attribute.

A contract modeler builds contract models for valuating claims. When a contract model is being built, and entry of a particular service term is received, the contract modeler searches for criteria templates that are associated with the service term. A criteria template is selected, and the criteria in the criteria template are automatically loaded into a criteria section of the contract modeler graphical user interface.

The contract modeling and claim valuation system enables one-time entry of criteria to be saved as a template so that when similar terms are added to contract models in the future, the criteria do not have to be re-entered from scratch. Accordingly, an amount of input required to build a contract is reduced, thus improving the efficiency of contract modeling. Additionally, by reducing manual data entry, keying errors are minimized, thus improving the accuracy of contract modeling and claim valuation.

Although examples are presented primarily regarding the healthcare industry, these are presented as non-limiting examples, as service providers in other service industries may also make use of the present disclosure.

Aspects of systems and methods described herein may be practiced in hardware implementations, software implementations, and in combined hardware/software implementation. This summary is provided to introduce a selection of concepts; it is not intended to identify all features or limit the scope of the claimed subject matter.

### BRIEF DESCRIPTION OF THE DRAWINGS

Further features, aspects, and advantages of the invention represented by the examples described present disclosure will become better understood by reference to the following detailed description, appended claims, and accompanying Figures, wherein elements are not to scale so as to more clearly show the details, wherein like reference numbers indicate like elements throughout the several views, and wherein:

FIG. 1 is a data flow diagram of a contract modeling and claim valuation system operative to provide automated criteria template generation and criteria autofill in a contract model in an example environment;

FIG. 2 is a system level flow diagram showing the relationship between various components of the contract modeling and claim valuation system;

FIG. 3 illustrates one example of a contract modeling graphical user interface;

FIGS. 4A-D are flow charts showing general stages involved in an example method for improving the efficiency, functionality, and accuracy of systems for contract modeling and claim valuation;

FIGS. 5A-E illustrate various circuit diagrams for circuits operable to perform various rules and comparisons; and

FIG. 6 is a block diagram illustrating example physical components of a computing device with which aspects of the system may be practiced.

### DETAILED DESCRIPTION

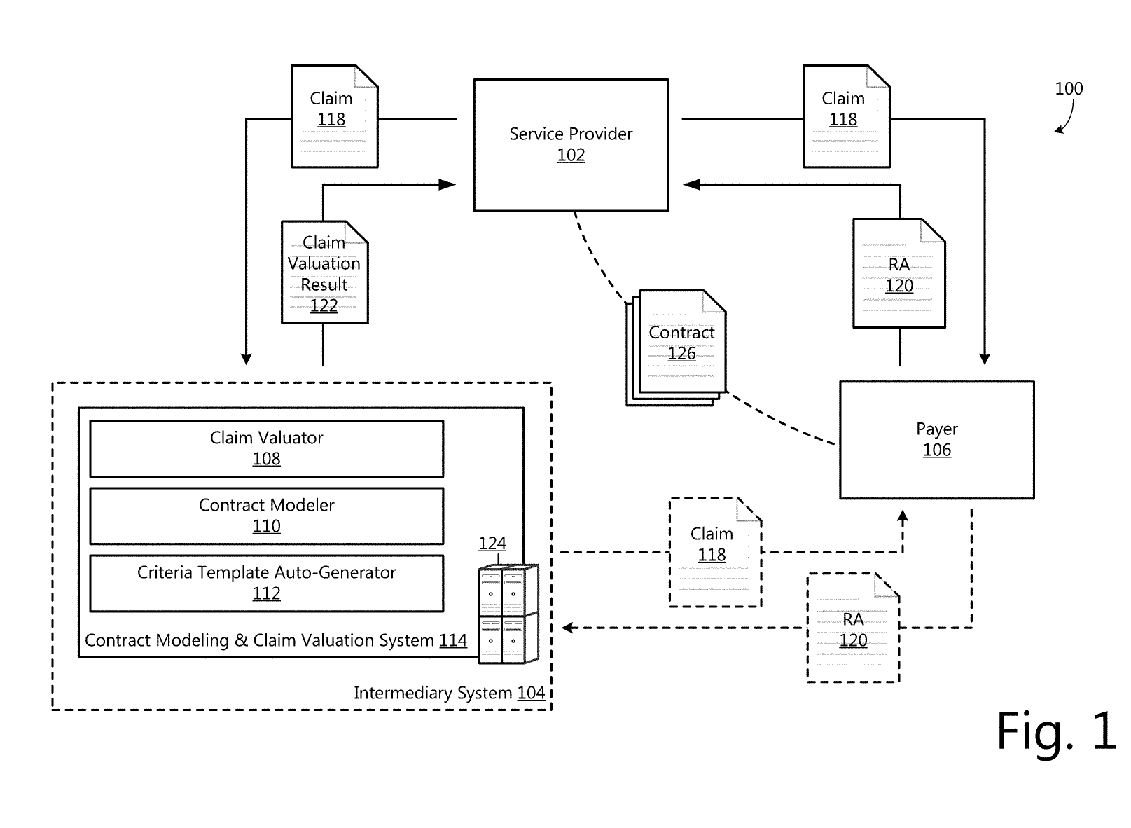

A contract modeling and claim valuation method and system are described herein and illustrated in the accompanying figures. The contract modeling and claim valuation system includes functionality for improving the efficiency, functionality, and accuracy of systems for contract modeling and claim valuation. FIG. 1 illustrates one example of the contract modeling and claim valuation system 114 in a suitable operating environment 100. Although some examples will herein be described in a healthcare environment, aspects are not limited to healthcare systems, and can be implemented in various environments, such as educational institutions providing education to students, attorneys providing legal services to clients, construction companies providing building and construction services to customers, automotive repair companies providing automobile repair services to customers, as well as other enterprises that provide various professional services to customers.

In some examples, the contract modeling and claim valuation system 114 is maintained and operated by a service provider 102. In other examples, the contract modeling and claim valuation system 114 is maintained and operated by an intermediary service provider system 104, wherein an intermediary service provider acts as an interface between the service provider 102 and payers 106. For example, in a healthcare system operating environment, the service provider 102 may be a healthcare provider (e.g., a physician, hospital, etc.), the payer 106 may be an insurance company, federal health plan, state health plan, etc., and the intermediary service provider functions as a HIPAA (Health Insurance Portability and Accountability Act) clearinghouse system that converts non-standard transactions (e.g., human-readable format) into standard HIPAA-compliant transactions or standard transactions into non-standard transactions.

The contract modeling and claim valuation system 114 may be a module or component of a larger health care information system or health care management suite offered by the intermediary service provider providing functionality including, but not limited to, any or all of patient intake, patient record maintenance, insurance eligibility verification, demographic information verification, order checking, financial clearance, and claim submission. While user interactions may be described as if directly handled by the contract modeling and claim valuation system 114, it should be appreciated that the user interactions may actually be handled by one or more other components of the larger system at different times and the information from those user interactions are made available to the contract modeling and claim valuation system 114.

As illustrated, the contract modeling and claim valuation system 114 includes a claim valuator 108, a contract modeler 110, and a criteria template auto-generator 112 running on one or a plurality of computing devices 124. For example, the functionality of the contract modeling and claim valuation system 114 may be distributed among multiple computing devices 124 or consolidated in a single computing device 124.

Consider, for example, that a person (patient) goes to a healthcare provider (service provider 102), such as an emergency department of a hospital, with appendicitis. From a medical report or superbill generated by the service provider 102, including a recording of observations and administrations of drugs and therapies, orders for the administration of drugs and therapies, test results, x-rays, reports, etc., a biller or administrative person associated with the service provider 102 enters relevant information for a claim 118, wherein a claim 118 is an itemized statement of services and costs from a service provider 102 submitted to a payer 106 for payment of services provided to a user, wherein the services are represented using a uniform coding language (e.g., using Current Procedural Terminology (CPT) codes).

For example, the biller enters procedure information and diagnostic information, as well as data about the patient, the patient's insurance (payer 106), the service provider 102, etc. According to examples, claims 118 are submitted in a standardized format according to HIPAA requirements, for example, an EDI 837 transaction set, wherein a coding system is used to provide uniform language that accurately describes medical, surgical, and diagnostic services. For example, CPT codes published by the American Medical Association are five digit numeric codes used to describe medical, surgical, radiology, laboratory, anesthesiology, and evaluation/management services of physicians, hospitals, and other health care providers. They provide uniformity and help simplify the health care claims process. Specific words and numbers refer to and describe specific medical procedures and services. Accordingly, the claim 118 for the example services provided to the example patient may include a listing of procedure codes, such as:

99284, (Emergency department visit for a condition that requires urgent evaluation by the physician . . . but [does] not pose an immediate significant threat to life or physiological function);

76705, ultrasound, abdominal, real time with image; limited (e.g. single organ);

44970, laparoscopy, surgical, appendectomy; and

00840-P3, Anesthesia for intraperitoneal procedures in lower abdomen including laparoscopy; not otherwise specified; patient with severe systemic disease; and

Diagnosis codes such as:

540.9, Acute appendicitis without mention of peritonitis.

The hospital (service provider 102) may then submit the claim 118 to the payer 106, and also submit the claim 118 to the claim valuator 108 for determining the amount (reimbursement) the hospital is expected to receive from the payer 106 based on a managed care contract 126 between the hospital (service provider 102) and the payer 106. Claims 118 may be sent one-by one or in a batch. In some examples, a remittance advice (RA) document 120 may be supplied by the payer 106 either directly to the service provider 102 or via the intermediary system 104, wherein the RA document 120 provides notice of and explanation reasons for payment, adjustment, denial and/or uncovered charges of a medical claim 118.

According to examples, the service provider 102 has a managed care contract 126 with the payer 106 that defines how the service provider 102 will be reimbursed by the payer 106, which is oftentimes a negotiated discount off charge master prices, is a set amount, or is another negotiated amount. For example, if a given payer is a private insurance company, the healthcare provider may be paid on a basis of per-diems or fee-for-service schedules. The service provider 102 may have managed care contracts 126 with a large number of payers 106, wherein each payer 106 may pay different amounts for a procedure or service based on the contract 126 it has with the service provider 126. To valuate and determine an expected reimbursement for a claim 118 from a particular service provider 102, criteria in an appropriate managed care contract 126 are used to determine if a particular term matches a billed item in the claim 118. Accordingly, the claim valuator 108 needs to comprise or have access to the managed care contract criteria to match against billed items in the claim 118.

The contract modeling and claim valuation system 114, the service provider 102, and the payer 108 communicate over a computer network, such as the Internet. According to an aspect, the contract modeling and claim valuation system 114 uses a combination of electronic data interchange (EDI) transactions, web services, web forms, and web pages to interactively communicate with the service provider 102 and the payer 108. Communications (i.e., messages) may be encrypted or otherwise secured at or above the level required to comply with applicable health care information privacy laws, regulations, and standards. The terms “request” and “response” may be used to generally describe message directionality and should not be construed as requiring any particular communication method or protocol.

EDI transactions are based on a standardized interface using strictly formatted messages representing documents that allows the contract modeling and claim valuation system 114, the service provider 102, and the payer 108 to exchange and understand information with little to no human intervention. Human intervention in the processing of a received message is typically limited to dealing with error conditions, quality review, and other special situations. Examples of a suitable EDI health care transaction formats include, but are not limited to, HL7, 278, and X12.

Web service transactions are through an interface described in a computer readable format such as the Web Service Definition Language (WSDL) that defines the access point(s), method(s), and other specifications of the web service. The web service uses protocols such as, but not limited to, the Simple Object Access Protocol (SOAP) for communication. The messages sent and received by the web service contain the actions and corresponding information specified in the web service definition. The messages are written using data formats such as, but not limited to, the Extensible Markup Language (XML) and the Security Assertion Markup Language (SAML). The messages are typically sent over the Internet using transport protocols such as, but not limited to, the Hypertext Transfer Protocol (HTTP), the Hypertext Transfer Protocol Secure (HTTPS), or the Simple Mail Transfer Protocol (SMTP). The web service may be a Representational State Transfer (REST) compliant service with a uniform set of methods or an arbitrary service with an arbitrary set of methods.

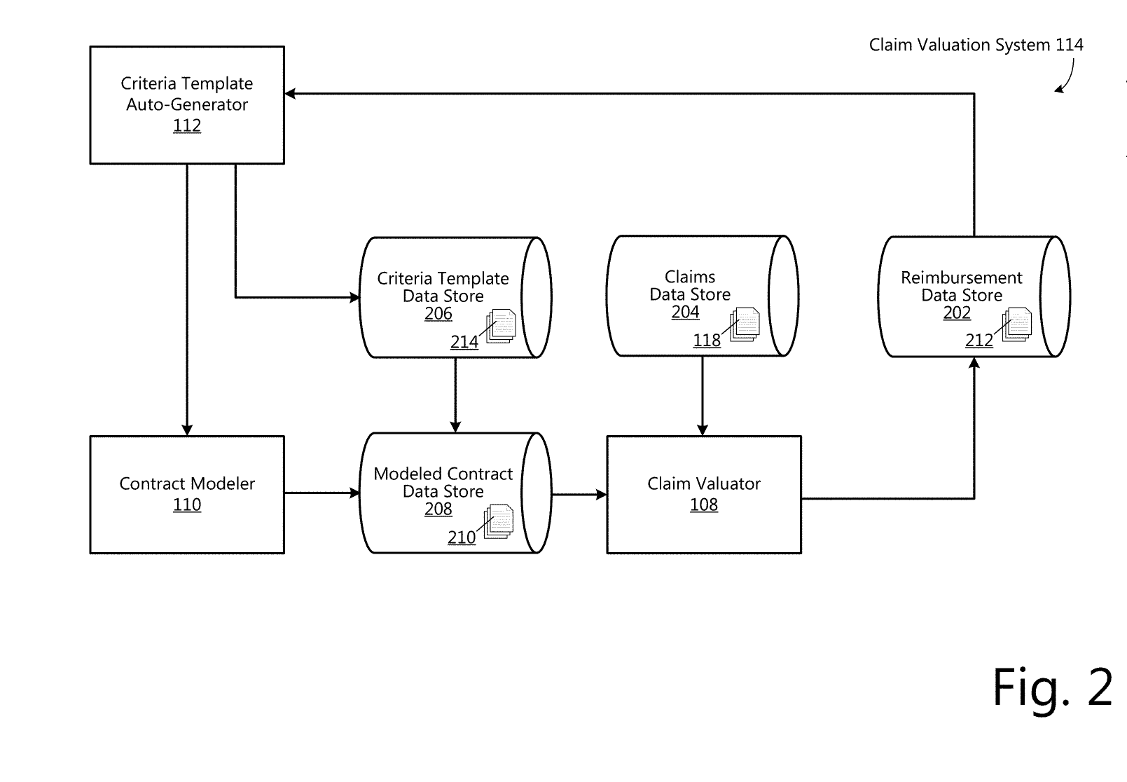

With reference now to FIG. 2, a system level flow diagram 200 showing the relationship between the claim valuator 108, the contract modeler 110, and the criteria template auto-generator 112 is illustrated. The claim valuator 108 is illustrative of a software module, system, or device operative to receive a claim 118, and determine an expected reimbursement for the claim 118 based on model contracts 210 generated by the contract modeler 110. The results of claim valuation 122 (i.e., reimbursement records 212) are stored in a reimbursement data store 202, and are used by the criteria template auto-generator 112 to create criteria templates 214, as described below.

For example, when the claim valuator 108 valuates a claim 118 and determines a reimbursement amount for the claim 118, a reimbursement record 212 for each service term in the claim 118 is created and stored in the reimbursement data store 202, wherein the reimbursement record 212 comprises the service term, the criteria used to match a claim item with a service term in a contract model 210, and the calculated reimbursement amount for the service term. According to an aspect, reimbursement records 212 are stored in a table. In one example, all possible services that can be rendered by a service provider 102 are entered in the table. As claims 118 are valuated, the claim valuator 108 pulls the claims 118 from storage in the claim data store 204, processes the claims 118, and stores the reimbursement for each service term, the criteria that were used to match against billed items in the claim 118 to valuate the service term(s), and the calculated reimbursement amount(s).

The criteria template auto-generator 112, illustrative of a software module, system, or device, is operative to build criteria templates 214 based on historical data, for example, based on a set of criteria associated with terms that have matched various services (in a claim 118) during previous claim valuations. In one example, the criteria template auto-generator 112 is operative to query the table for a particular service term, receive a listing of one or more sets of criteria associated with the service term, and generate a criteria template 214 including the criteria in the set. The criteria template auto-generator 112 is further operative to store criteria templates in a criteria template data store 206.

According to an example, when a particular service term has been satisfied with more than one set of criteria in previous claim valuations, the criteria template auto-generator 112 is operative to generate a plurality of criteria templates 214 for the particular service term. The criteria template auto-generator 112 is further operative to prioritize criteria templates based on an attribute. In one example, the criteria template auto-generator 112 prioritizes criteria templates 214 based on frequency (e.g., which criteria set is most frequently associated with the service term). In another example, the criteria template auto-generator 112 prioritizes criteria templates 214 based on reimbursement amount for the service term. Other attributes may be utilized to prioritize criteria templates 214.

As claims 118 continue to be valuated, the criteria template auto-generator 112 continues to build criteria templates 214 and update existing criteria templates 214. For example, the criteria template auto-generator 112 is operative to update existing criteria templates 214 with the most frequently used sets of criteria that satisfy particular service terms.

The contract modeler 110, illustrative of a software module, system, or device, is operative to generate contract models 210 representative of managed care contracts 126, and store the contract models 210 in a modeled contracts data store 208. The contract models 210 are used by the claim valuator 108 to match term criteria in contracts 126 against billed items (i.e., claim codes) in claims 118 to valuate the claims 118 for determining an expected reimbursement. In one example, a contract model 210 is generated when criteria, in the form of revenue codes, Healthcare Common Procedure Coding System (HCPCS) codes, Diagnosis Related Group (DRG) codes, charge amounts, patient age, etc., that are associated with reimbursement terms in the contract 126 are input into the contract modeler 110. For example, prior to aspects of the present disclosure, a contract analyst may manually input criteria into a criteria section of a contract modeler 110 graphical user interface (GUI) displayed on a screen of a computing device 124.

To reduce keying input, to provide a more efficient process of entering term criteria into a contract model 210, and to reduce errors when entering term criteria, the contract modeler 110 is operative to automatically load suggested criteria according to a criteria template 214. According to an aspect, upon receiving an input of a service term to generate a contract model 210, the contract modeler 110 locates all applicable criteria templates 214 generated by the criteria template auto-generator 112, selects a criteria template that matches the service term, and automatically loads the criteria included in the criteria template into the criteria section of the GUI.

According to one example, the contract modeler 110 automatically fills the highest ranking criteria set for the service term in the criteria section as determined by the criteria template auto-generator, and lists the remaining criteria templates in a selection list for display to a user, such as a contract analyst. Accordingly, automatically populating criteria reduces input steps required by a contract analyst, and thus improves usability of the contract modeler 110. Additionally by harnessing the storage and lookup capabilities of the computing device 124, the error rate of criteria input is reduced, thus enhancing reliability and accuracy of the modeling process and claim valuation process. The contract analyst is enabled to alter the criteria, for example, by adding additional criteria to or deleting criteria from the criteria section. Additionally, the contract analyst is enabled to save the altered criteria list as a new criteria template 214 for the service term.

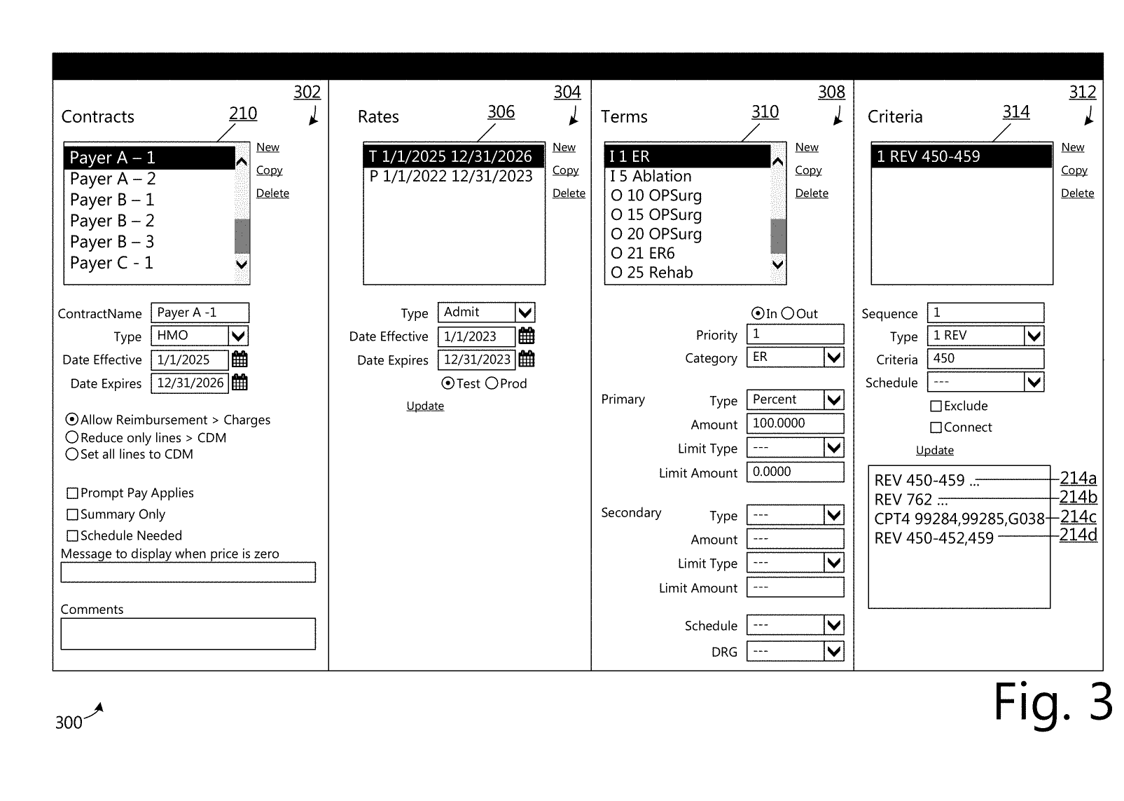

An example contract modeler 110 GUI 300 is illustrated in FIG. 3. A contract analyst may utilize a contract modeler 110 GUI 300, such as the example illustrated in FIG. 3, to enter contract 126 information, such as a contract's name, rate set, reimbursement terms, and criteria used to match contract terms to claim attributes to build a contract model 210 to valuate claims 118. For example, a contract specialist or payment analyst is enabled to interpret a contract 126 to determine what terms to define in the system for valuation of claims 118 by the claim valuator 108.

With reference now to FIG. 3, the example contract modeler 110 GUI 300 includes a contracts section 302, where a listing of existing contract models 210 are displayed, and where new contract models 210 can be built. The example contract modeler 110 GUI 300 further includes a rates section 304, where rate sets can be defined and given effective date ranges 306, wherein a rate set may be used to determine which terms apply when valuating a claim 118. The example contract modeler 110 GUI 300 further includes a terms section 308, where service term 310 can be input. For example, each service term 310 relates to a section in the managed care contract 126 that is being modeled. A user is enabled to define the type of service term 310, its hierarchy in a list of terms, an how the service term is to be valuated (e.g., flat rate, percentage, DRG).

As illustrated, a criteria section 312 is included in the example contract modeler 110 GUI 300. As described above, when a service term 310 is input into the contract modeler 110, the contract modeler 110 locates applicable criteria templates 214 (that match the service term 310) generated by the criteria template auto-generator 112, selects a criteria template 214 comprising a set of one or more criteria 314, and automatically loads the one or more criteria 314 into the criteria section 312 of the GUI 300 according to the criteria template 214. According to an aspect, the criteria template 214 is selected based on a priority ranking.

In one example, the contract modeler 110 selects the criteria template 214 comprising the most frequently used set of criteria 314 for the service term 310 according to reimbursement records 212 stored in the reimbursement data store 202, wherein frequency of use is the metric for prioritization. In another example, the contract modeler 110 selects the criteria template 214 comprising a set of criteria 314 matching a specific attribute, for example, as selected by a user. For example, the user (e.g., contract analyst) may select to use a set of criteria 314 that yields the highest reimbursement for the service term 310, wherein the reimbursement amount is the metric for prioritization. Accordingly, the criteria template 214 comprising the set of criteria 314 yielding the highest reimbursement amount is selected, and the criteria 314 are automatically loaded into the criteria section 312.

According to an aspect, when additional criteria templates 214 for the service term 310 exist, the additional criteria templates 214 are displayed in order of priority. As illustrated in FIG. 3, the criteria 314 included in the highest ranking criteria template 214a are automatically populated in the criteria section 312, and additional criteria templates 214b-d that match the service code 310 are displayed in order of priority. The user is enabled to select a different criteria template 214b-d, or may enter entirely new criteria 314 if desired. Further, the user is enabled to save entered criteria 314 as a new criteria template 214 to associate with the service term 310.

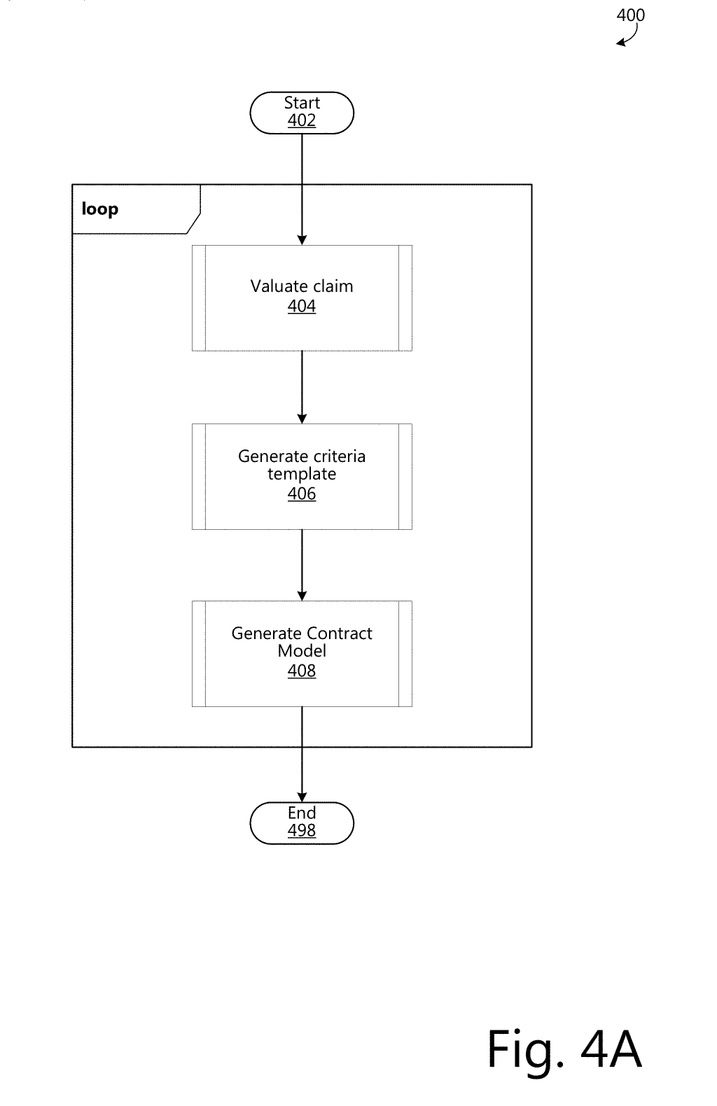

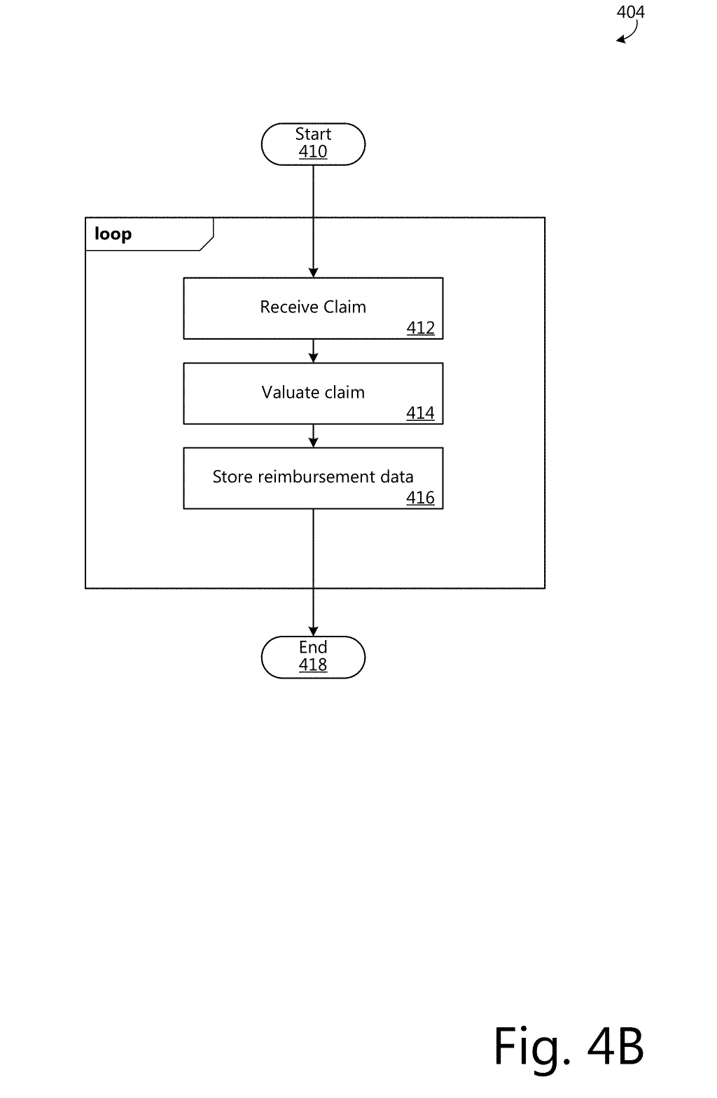

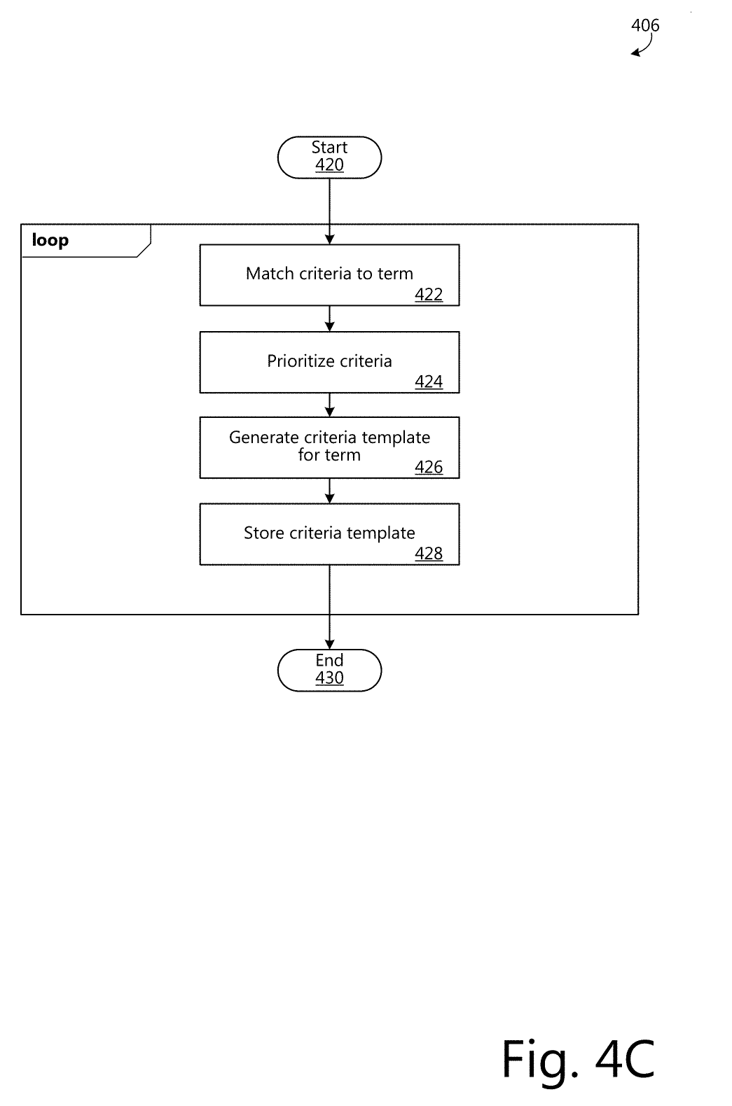

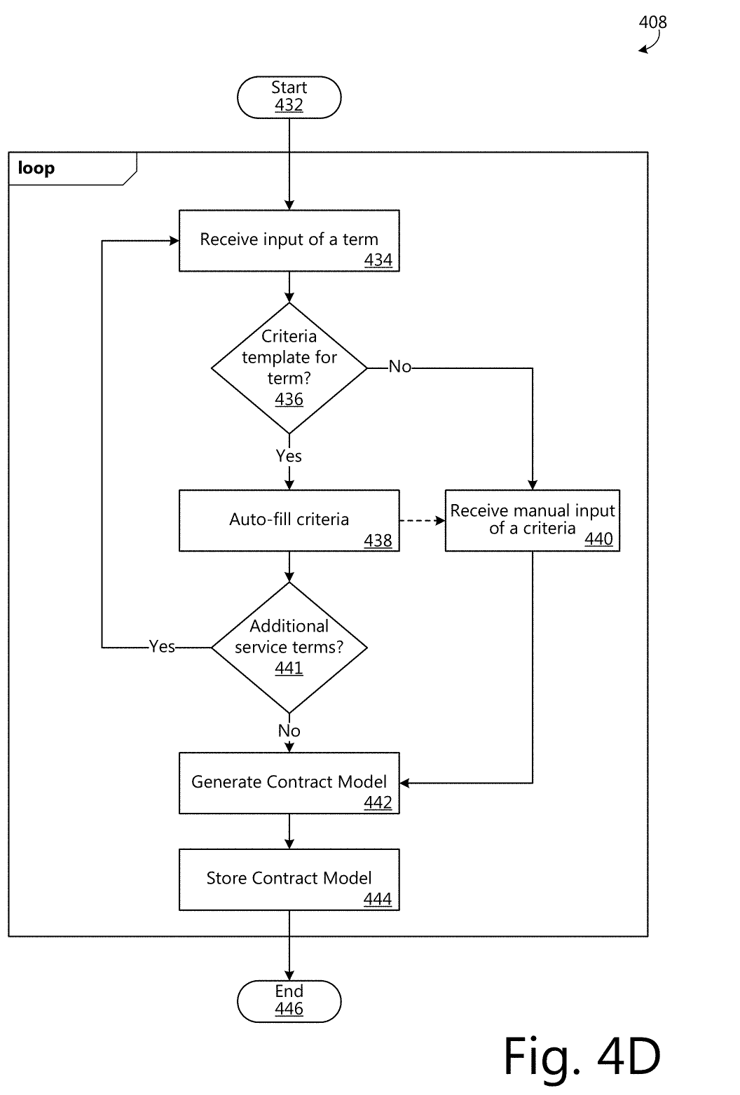

FIG. 4A is a high level flow chart showing general stages involved in an example method 400 for improving the efficiency, functionality, and accuracy of systems for contract modeling and claim valuation. The method 400 starts at OPERATION 402, and proceeds to OPERATION 404, where a claim 118 is valuated. At OPERATION 404, the claim valuator 108 determines an amount (reimbursement) the service provider 102 is expected to receive for a claim 118 from a payer 106 based on a managed care contract 126 between the service provider 102 and the payer 106, and stores a record of the valuation.

The method 400 proceeds to OPERATION 406, where a criteria template 214 is generated based on results of claim valuation 122 (404). For example, the criteria template auto-generator 112 reads the criteria 314 associated with service terms 310 that have matched a service during claim valuations, and creates a criteria template 214 for the service term 310 including one or more criteria 314 associated with the service term.

The method 400 proceeds to OPERATION 408, where a contract model 210 is generated. For example, when a user utilizes the contract modeler 110 to build a contract model 210, entry of a particular service term 310 causes the contract modeler 110 to locate all criteria templates 214 related to the service term 310, and automatically fill one or more criteria 314 into a criteria section 312 of the contract modeler GUI 300. Accordingly, rather than having to manually enter criteria for each service term 310 when modeling a contract 126, a user can enter criteria 314 once for a given service term 310. When the user or another user needs to enter the service term 310 in a contract model 210, criteria 314 associated with the service term 310 will automatically populate, thus reducing keying and reducing likely errors associated with keying in data. The method 400 ends at OPERATION 498.

FIG. 4B is one example of a high level flow chart showing general stages involved in a method (404) for valuating a claim 118 (OPERATION 404). The method 404 starts at OPERATION 410, and proceeds to OPERATION 412, where the claim valuator 108 receives a claim 118. The method 404 continues to OPERATION 414, where the claim valuator 108 matches a contract model 210, representative of the managed care contract 126 between the service provider 102 and the payer 106, against services (and other attributes) in the claim 118. For example, the contract model 210 is matched by successively comparing the criteria 314 associated with each service term 310 with services (and other attributes) in the claim 118, wherein the criteria 314 comprise at least one of: procedure codes, revenue codes, diagnostic codes, and DRG codes.

At OPERATION 414, a reimbursement amount for each service term 310 is calculated, and at OPERATION 416, the contract valuator 108 stores a reimbursement record 212 comprising each matched service term 310, the criteria used to match claim procedures with each service term 310, and the reimbursement amount(s) in the reimbursement data store 102. OPERATIONS 412-416 continue in a loop for each claim 118 that is valuated. The method 404 ends at OPERATION 418.

FIG. 4C is one example of a high level flow chart showing general stages involved in a method (406) of generating a criteria template 214 (OPERATION 406). The method 406 starts at OPERATION 420, and proceeds to OPERATION 422, where the criteria template auto-generator 112 reads historical reimbursement data from the reimbursement data store 202 generated by previous claim valuations (404), and determines which criteria 314 are associated with service terms 310.

The method 404 continues to OPERATION 424, where the criteria template auto-generator 112 searches for criteria 314 that are associated with a particular service term 310 according to an attribute, and prioritizes the criteria 314 according to the attribute. In one example, the criteria template auto-generator 112 searches for a criterion or a set of criteria 314 that are most frequently associated with a particular service term 310.

The method 404 proceeds to OPERATION 426, where the criteria template auto-generator 112 generates one or more criteria templates 214 for the particular service term 310, and at OPERATION 428, the criteria template auto-generator 112 stores the one or more criteria templates 214 in the criteria template data store 206. OPERATIONS 422-428 continue in a loop for each service term 310. The method 404 ends at OPERATION 430.

FIG. 4D is one example of a high level flow chart showing general stages involved in generating a contract model 210 (OPERATION 408). The method 408 starts at OPERATION 432, and proceeds to OPERATION 434, where the contract modeler 110 receives an input of a service term 310. For example, an input of a service term 310 is received when a user utilizes the contract modeler 110 to build a contract model 210.

The method 408 proceeds to DECISION OPERATION 436, where a determination is made as to whether a criteria template 214 has been created for the service term 310. For example, the contract modeler 110 queries the criteria template data store 206 for a criteria template 214 associated with the particular service term 310.

When a determination is made that one or more criteria templates 214 have been created for the particular service term 310, the method 408 proceeds to OPERATION 438, where the contract modeler 110 loads the one or more criteria templates 214, and automatically fills a criterion or a plurality of criteria 314 into a criteria section 312 of the contract modeler GUI 300. In one example, the contract modeler 110 selects the criteria template 214 that has a highest priority ranking according to frequency of use for the service term 310.

When a determination is made that a criteria template 214 has not been created for the particular service term 310 at DECISION OPERATION 436, or optionally from OPERATION 438, the method 408 proceeds to OPERATION 440, where manual input of criteria data is received. For example, the user may input criteria, modify the criteria, select another criteria template 214, etc.

At DECISION OPERATION 441, a determination is made as to whether all service terms 310 in the contract 126 that is being modeled have been entered into the contract modeler GUI 300. When a determination is made that there are additional service terms 310 that need to be entered, the method 408 returns to OPERATION 434, where an additional service term 310 is received.

When a determination is made that all the service terms 310 in the contract 126 have been entered, the method 408 proceeds to OPERATION 442, where the contract model 210 is generated. At OPERATION 444, the contract model 210 is stored in the modeled contracts data store 208. OPERATIONS 434-444 continue in a loop for each managed care contract 126 that needs to be modeled. The method 408 ends at OPERATION 446.

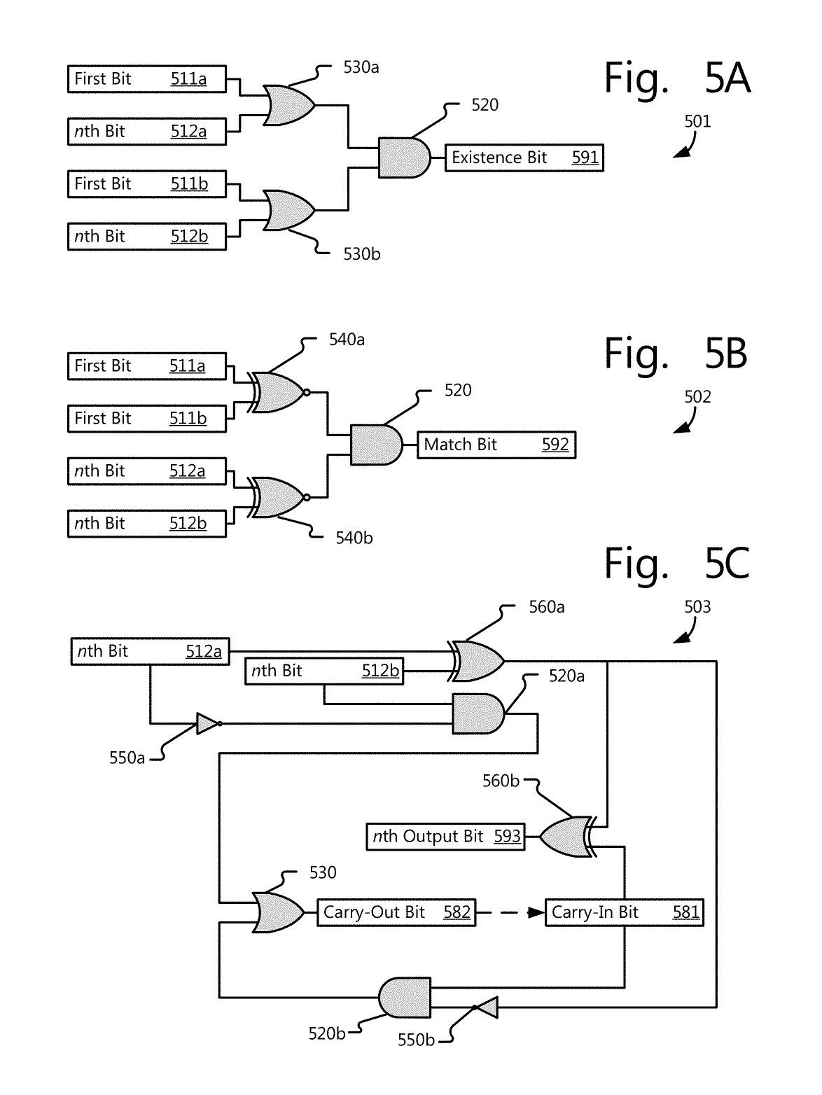

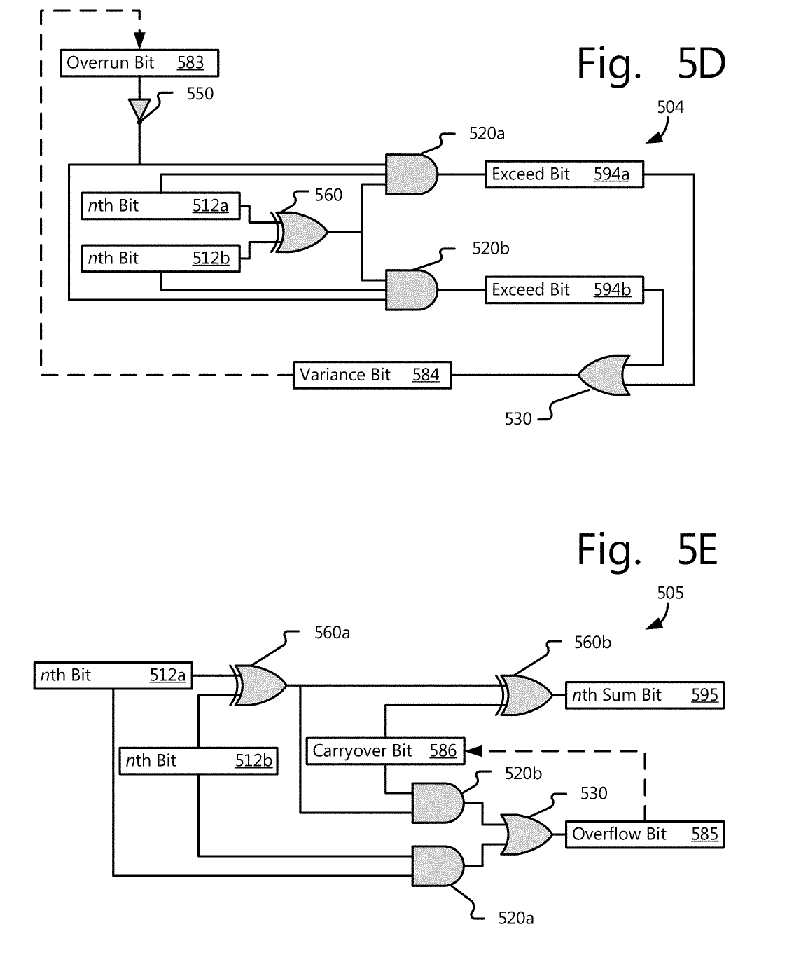

FIGS. 5A-E illustrate various circuit diagrams for circuits applicable to digital devices, such as the claim valuator 108, the contract modeler 110, and the criteria template auto-generator 112, operable to perform various rules and comparisons as part of the systems and devices of the present disclosure. As illustrated in FIGS. 5A-E, bits from a first data source are labeled with an “a” and bits from a second data source are labeled with a “b” so that their source may be readily apparent. First input bits 511 and nth input bits 512 correspond to different bits on which data are encoded, comprising the data from the first and second data sources being compared, such that first input bit 511a and nth input bit 512a are from the first data source, and first input bit 511b and nth input bit 512b are from the second data source.

The circuits are sized to accommodate the largest possible data field from the claim valuator 108, the contract modeler 110, or the criteria template auto-generator 112. For example, when a data field contains a maximum of twelve characters, each character being encoded in one byte (e.g., according to ASCII or a basic Latin set from the UTF-8 standard), the logic gate array will accept up to 192 inputs (i.e., 12*8*2 inputs). When the data within a data field do not fully fill that data field, such as when only twelve characters are encoded in a field with a maximum size of thirteen characters, any unused bits may be set to zero/FALSE or no input to the corresponding leads of a given logic gate array will provided.

An arrayed logic gate will accept multiple inputs to produce a single output per the truth table of the logic gate. For example, an AND logic gate array 520 will accept n inputs and produce one output, wherein than one output will return zero/FALSE unless all of the n inputs are one/TRUE, in which case it will return one/TRUE. In another example, an OR logic gate array 530 will accept n inputs and will produce one output, wherein that one output will return one/TRUE if any of the n inputs is one/TRUE, otherwise the logic gate array will return zero/FALSE. One of ordinary skill in the art will be familiar with the truth tables of different logic gate arrays. One of ordinary skill in the art will also be familiar with the construction of logic gate arrays from various transistors (e.g., Bipolar Junction (BJT), Field Effect (FET), etc.), diodes, resistors, memristors, and combinations thereof that are stand-alone electrical components, part of an integrated circuit, or provided by a processor.

As will be appreciated, a rule may make multiple uses of one or more of the example circuits to provide greater nuance in comparisons between data sources. For example, multiple existence checks may be performed against a rule definition to determine whether an input falls outside of a range (or falls within a category of a plurality of categories). The multiple outputs from these circuits may be combined via AND or OR operations to return a passing state or a failing state of the rule. Alternatively, when only one circuit is used, its output's state may be used to return a passing or failing state of the rule.

FIG. 5A is an example diagram of an existence circuit 501 corresponding to a rule for comparing whether data coexist in data inputs. As illustrated, each of the bits from two data sources are input into an OR logic gate array 530. First input bit 511a through nth input bit 512a from the first data source are fed into a first OR logic gate array 530a, and first input bit 511b through nth input bit 512b from the second data source are fed into a second OR logic gate array 530b. The output of the first OR logic gate array 530a is then combined with the output of the second OR logic gate array 530b via an AND logic gate array 520 to produce an existence bit 591 to indicate that the data from the first and second data sources exist, as defined by each other, with a one/TRUE value, or that at least one does not exist with a zero/FALSE value. As will be appreciated, if the first data source represents a rule definition that is known to exist, the first OR logic gate array 530a may be replaced with a one/TRUE value input to reduce the number of logic gate arrays required.

FIG. 5B is an example diagram for a matching circuit 502 corresponding to a rule for comparing whether the data from the first and second data sources match. Each bit from the first data source is combined with the corresponding bit from the second data source via an XNOR logic gate array 540. For example, a first input bit 511a from a rule definition will be XNORed with a first input bit 511b from the reimbursement records 212 via a first XNOR logic gate array 540a, and an nth input bit 512a from a rule definition will be XNORed with an nth input bit 512b from the reimbursement records 212 via an nth XNOR logic gate array 540b. The output of the first XNOR logic gate array 540a is then combined with the output of the nth XNOR logic gate array 540b via an AND logic gate array 520 to produce a match bit 592 to indicate a match with a one/TRUE value, or no match with a zero/FALSE value.

A rule may allow for inexact matches as well as exact matches. Therefore, the input bits to the matching circuit 502 may be substituted or discarded from consideration via bit shifting or ignoring portions of the data to be compared. For example, input data for a personal name may be “DOE JOHN”, whereas a rule definition for a name may have “DOE JOHN Q”, and the bits used to encode the extra “Q”, which are not found in the input data, may be ignored so that the data may be considered to be matching. Similarly, if a different rule definition used the name value “DOE JONATHAN”, the term “JONATHAN” could be recognized by a separate matching circuit 502 so that the term “JOHN” may be substituted for “JONATHAN” when comparing the data, so that an inexact match will return one/TRUE. In various aspects, the separate circuits for exact and inexact matches may be combined via an OR gate to provide a single output.

FIG. 5C is an example diagram for a bitwise subtractor circuit 503 corresponding to a rule for finding the difference between two sets of data. In various aspects, before subtracting one set of data from another, the values of those data are converted from character representations of digits of that number (e.g., in the UTF-8 or ASCII formats) to a binary representation of that number. For example, the number twelve in UTF-8 format is represented as two characters (i.e., “1” and “2”), each with its own encoding for the digit it represents (0011 0001ₓ₂ and 0011 0010ₓ₂, respectively), whereas the number twelve in binary notation is represented as 0000 1100ₓ₂. As will be understood, there are multiple ways to represent a number in a binary format that account for negative and fractional numbers, and the precise format may vary in different aspects so long as the number is represented as a whole and not via individual representations of the digits.

As will be recognized, bitwise subtraction operations include inputs bits for a minuend, a subtrahend, and a carry-in, and produce outputs bits for a difference and a carry-out. The minuend is the input from which the subtrahend is subtracted, which are illustrated as the nth input bit 512a from the first data source and the nth input bit 512b from the second data source respectively.

A carry-in bit 581 represents “carry-over” from a previous bitwise subtraction operation (e.g., from the (n−1)th bits from the two data sources) and a carry-out bit 582 represents “carry-over” from the current operation to the next bitwise subtraction operation (e.g., for the (n+1)th bits from the two data sources). The carry-in bit 581 for the first bits subtracted will be zero/FALSE, but for any subsequent bits will be equal to the carry-out bit 582 from the previous bits' operation. Thus, for subtraction of numbers represented n bits, n or more bitwise subtractor circuits 503 are chained together by their carry-in bits 581 and carry-out bits 582, and the chain begins with the least significant bits representing the two numbers.

In the example diagram, the value of the carry-out bit 582 is determined via an OR logic gate array 530, which takes its inputs from the outputs of a first AND logic gate array 520a and a second AND logic gate array 520b. The first AND logic gate array 520a uses the subtrahend and an inversion of the minuend's value, via first inverter 550a, as inputs for an AND operation. The second AND logic gate array 520b uses the carry-in bit 581 and an inversion, via second inverter 550b, of a XORing, via first XOR logic gate array 560a, of the minuend and the subtrahend as inputs for an AND operation.

In the example diagram, the minuend is XORed with the subtrahend via the first XOR logic gate array 560a, which is in turn XORed with the carry-in bit 581 via the second XOR logic gate array 560b to produce the nth output bit 593. The carry-in bit 581 is equal to the carry-out bit 582 for the previous subtraction operation. Each operation of the bitwise subtractor circuit 503 results in one output bit 593, and the output bits 593 are assembled into the difference between the numbers from the two structured sets of data in order from least significant bit to most significant bit. For example, for the operation of four (0100ₓ₂) minus two (0010ₓ₂), the first output bit 593 would be zero/FALSE and the second output bit 593 would be one/TRUE to yield the difference of two (0010ₓ₂) with zero/FALSE in the least significant position and one/TRUE in the next most significant position based on the order of output from the example bitwise subtractor circuit 503.

In various aspects, a series of subtractor circuits 503 are used in combination with an existence circuit 501 to determine whether a value exceeds the bounds of a threshold rule. For example, for determining whether a value is greater than a threshold, a series of subtractor circuits 503 will be used subtract a threshold from a value, and the result is checked via an existence circuit 501 to see if the result has a positive value, indicating that the value is greater than the threshold. In an alternative example, for determining whether a value is less than a threshold, series of subtractor circuits 503 will be used to subtract the value from the threshold, and the result is checked via an existence circuit 501 to see if the result has a positive value, indicating that the value is less than the threshold. As will be appreciated, depending on how negative and positive values are tracked, a bit used to indicate sign (i.e., positive or negative), may be ignored by the existence circuit 501 in the above examples.

FIG. 5D is an example diagram for a bitwise sizing circuit 504 corresponding to a rule for finding which of two sets of data has the greater (or lesser) value. A sizing circuit 504 may be used to determine whether input from a first data source exceeds input from a second data source. Similarly to a subtractor circuit 503, the values of these data are converted from character representations of digits of a number to a binary representation of that number as a whole before inputting those data to the sizing circuit 504. As will be understood, there are multiple ways to represent a number in a binary format that account for negative and fractional numbers, and the precise format may vary in different aspects so long as the number is represented as a whole and not via individual representations of the digits.

As will be recognized, bitwise sizing operations include inputs bits from the data sources to compare and an overrun, and produce outputs bits for indicating whether one set of data is greater than the other and a variance. The inputs from the data sources are illustrated as the nth input bit 512a from the first data source and the nth input bit 512b from the second data source respectively.

An overrun bit 583 represents “carry-over” from a previous bitwise sizing operation (e.g., from the (n+1)th bits from the two data sources) and a variance bit 584 represents “carry-over” from the current operation to the next bitwise sizing operation (e.g., to the (n−1)th bits from the two data sources). The overrun bit 583 for the first bits sized will be zero/FALSE, but for any subsequent bits will be equal to the variance bit 584 from the previous bits' operation. Thus, for sizing numbers represented n bits, n or more bitwise sizing circuits 504 are chained together by their overrun bits 583 and variance bits 584, and the chain begins with the most significant bits representing the two numbers. As will be appreciated, if a given number includes fewer bits in its representation than another number, it will be padded with leading zeroes so that the comparison of most significant bits will compare the same values, accounting for any bits used for designating negative/positive values (e.g., when comparing binary five (0101ₓ₂) to binary twenty-five (0001 1001ₓ₂), binary five may be padded to be represented as 0000 0101ₓ₂ for a bitwise comparison with twenty-five).

In the example diagram, each exceed bit 594 represents whether the associated nth input bit 512 is larger than the nth input bit 512 from the other data source. For example, first exceed bit 594a will be one/TRUE when first nth input bit 512a (associated with the first data source) exceeds second nth input bit 512b (associated with the second data source). Similarly, second exceed bit 594b will be one/TRUE when second nth input bit 512b exceeds first nth input bit 512a. A given bit exceeds another bit when the given bit is equal to one/TRUE and the other bit is equal to zero/FALSE.

Starting with the most significant bits, nth input bit 512a is compared with nth input bit 512b via an XOR logic gate array 560, the result of which is input to first AND logic gate array 520a and second AND logic gate array 520b. Each of the AND logic gate arrays 520 also accept an inversion of the overrun bit 583, produced by inverter 550, and the associated nth input bit 512 as inputs. First AND logic gate array 520a produces exceed bit 594a to indicate that nth input bit 512a exceeds nth input bit 512b, and that no data source in a previous iteration was determined to exceed the other by setting exceed bit 594a to one/TRUE, and otherwise setting it to zero/FALSE. Second AND logic gate array 520b produces exceed bit 594b to indicate that nth input bit 512b exceeds nth input bit 512a, and that no data source in a previous iteration was determined to exceed the other by setting exceed bit 594b to one/TRUE, and otherwise setting it to zero/FALSE.

To ensure that the sizing circuit 504 tracks whether bits of greater significance from the data sources have already determined that one dataset is greater than the other, the first exceed bit 594a and the second exceed bit 594b are combined via an OR logic gate array 530 to produce the variance bit 584. The value of the variance bit 584 is used as the value for the overrun bit 583 for the next-most significant bit to be compared by the sizing circuits 504 in the series.

When the data from the first and second data sources are equal, the exceed bits 594a, 594b will all produce zero/FALSE, but when the data from one data source exceeds the other's data (i.e., has a higher value), the associated exceed bit 594 from the first iteration of the chain of sizing circuits 504 that determines that one set of data exceeds the other will produce one/TRUE and all other exceed bits 594 will produce zero/FALSE. As will be appreciated, each of the first exceed bits 594a and second exceed bits 594b may be aggregated and combined via associated aggregating OR logic gate arrays 530 (not illustrated; one for all the first exceed bits 594a and one for all the second exceed bits 594b) between each iteration of the sizing circuit 504 for a single determination to be provided. Alternatively, each iteration of the sizing circuit 504 in a chain of sizing circuits 504 may write to the same bit, if the variance bit 584 enables a breakout from the series of circuits, in which case the overrun bit 583, inverter 550, and supporting circuitry may be omitted.

FIG. 5E is an example diagram for a bitwise full-adder circuit 505 corresponding to a rule for finding the sum of two sets of data. Similarly to subtractor circuits 503 and sizing circuits 504, the values of these data are converted from character representations of digits of a number to a binary representation of that number as a whole before inputting those data to the full-adder circuit 505. As will be understood, there are multiple ways to represent a number in a binary format that account for negative and fractional numbers, and the precise format may vary in different aspects so long as the number is represented as a whole and not via individual representations of the digits.

As will be recognized, bitwise addition operations include inputs bits for the terms to be added and a carryover, and produce outputs bits for a sum and an overflow. The terms are the bits from the data sources, which are illustrated as the nth input bit 512a from the first data source and the nth input bit 512b from the second data source respectively.

A carryover bit 586 represents “carry-over” from a previous bitwise addition operation (e.g., from the (n−1)th bits from the two data sources) and an overflow bit 585 represents “carry-over” from the current operation to the next bitwise addition operation (e.g., for the (n+1)th bits from the two data sources). The carryover bit 586 for the first bits added will be zero/FALSE, but for any subsequent bits will be equal to the overflow bit 585 from the previous bits' operation. Thus, for addition of numbers represented n bits, n or more bitwise full-adder circuits 505 are chained together by their carryover bits 586 and overflow bits 585, and the chain begins with the least significant bits representing the two numbers, which is referred to as a ripple full-adder.

As illustrated, nth sum bit 595 is the product of an XOR operation at second XOR logic gate array 560b of the carryover bit 586 and the product of the first XOR logic gate array 560a of the nth input bit 512a and the nth input bit 512b. To produce the overflow bit 585, which is used as the carryover bit 586 for a subsequent full-adder circuit 505 in a ripple full-adder, the output of the first AND logic gate array 520a and the output of the second AND gate array 520b are ORed by OR logic gate array 530. The first AND logic gate array 520a uses the carryover bit 586 and the output of the first XOR logic gate array 560a as inputs, and the second AND logic gate array 520b uses the nth input bit 512a and the nth input bit 512b as inputs. For example, for the operation of one (0001ₓ₂) plus three (0011ₓ₂), the first sum bit 595 would be zero/FALSE (with an first overflow bit 585 of one/TRUE), the second sum bit 595 would be zero/FALSE (with an first overflow bit 585 of one/TRUE), the third sum bit 595 would be one/TRUE (with an first overflow bit 585 of zero/FALSE), to yield the sum of four (0100ₓ₂) with zero/FALSE in the two least significant positions and one/TRUE in the second most significant position based on the order of output from the example bitwise full-adder circuit 505.

Aspects of the present disclosure are implemented via local, remote, or a combination of local and remote computing and data storage systems. Such memory storage and processing units are implemented in a computing device, such as computing device 600. Any suitable combination of hardware, software, or firmware is used to implement the memory storage and processing unit. For example, the memory storage and processing unit is implemented with computing device 600 or any other computing devices 618, in combination with computing device 600, wherein functionality is brought together over a network in a distributed computing environment, for example, an intranet or the Internet, to perform the functions as described herein. Such systems, devices, and processors (as described herein) are examples and other systems, devices, and processors comprise the aforementioned memory storage and processing unit, consistent with embodiments of the invention.

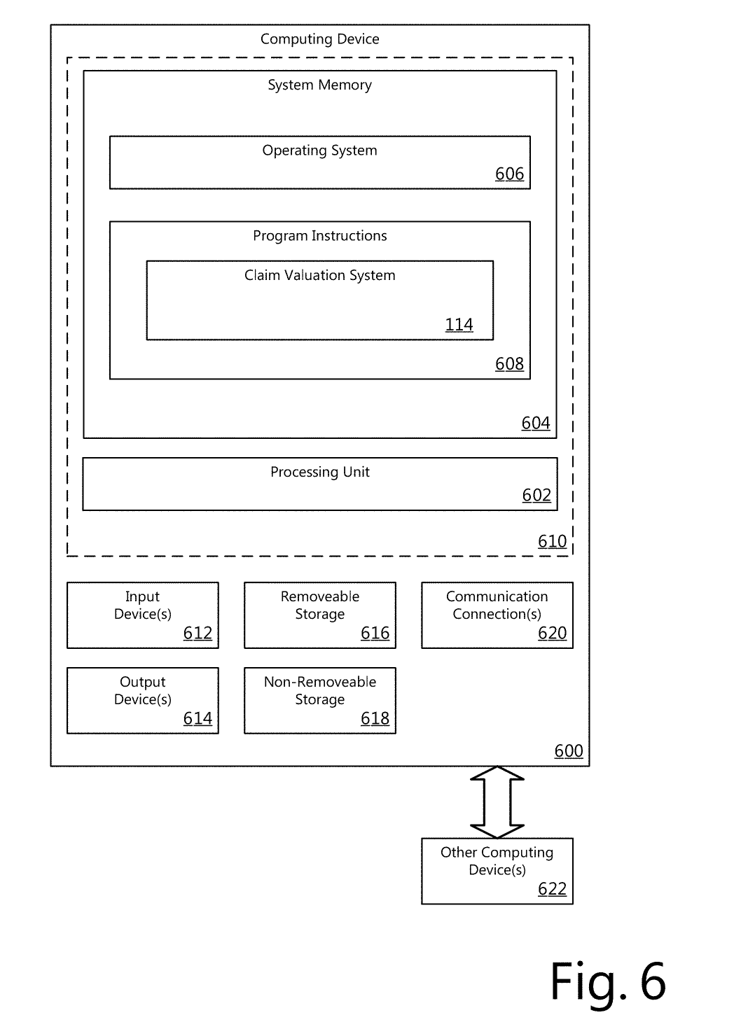

FIG. 6 illustrates one example of a computing device suitable to implement aspects of the present disclosure. The computing device 600 includes at least one processing unit 602 and a system memory 604. The system memory 604 comprises, but is not limited to, volatile (e.g. random access memory (RAM)), non-volatile (e.g. read-only memory (ROM)), flash memory, or any combination. System memory 604 includes operating system 605, one or more program instructions 608, and according to an aspect, includes the contract modeling and claim valuation system 114, which when executed, performs functionalities as described herein. Operating system 605, for example, is suitable for controlling the operation of computing device 600. Furthermore, according to an aspect, features of the present disclosure are practiced in conjunction with a graphics library, other operating systems, or any other application program, and is not limited to any particular application or system. This basic configuration is illustrated by those components within a dashed line 610. According to an aspect, computing device 600 includes one or more input device(s) 612 (keyboard, mouse, pen, touch input device, etc.) and one or more output device(s) 614 (e.g., display, speakers, a printer, etc.).

According to an aspect, the computing device 600 includes additional data storage devices 616/618 (removable and/or non-removable) such as, for example, magnetic disks, optical disks, or tape. According to an aspect, computing device 600 comprises a communication connection 620 that allows device 600 to communicate with other computing devices 622, such as over a network in a distributed computing environment, for example, an intranet or the Internet. Communication connection 620 is one example of communication media.

According to an aspect, program modules, such as the contract modeling and claim valuation system 114, include routines, programs, components, data structures, and other types of structures that perform particular tasks or that implement particular abstract data types. Moreover, according to an aspect, features of the present disclosure are practiced with other computer system configurations, such as hand-held devices, multiprocessor systems, microprocessor-based or programmable user electronics, minicomputers, mainframe computers, and the like. According to an aspect, features of the present disclosure are practiced in distributed computing environments where tasks are performed by remote processing devices that are linked through a communications network. In a distributed computing environment, program modules are located in both local and remote memory storage devices.

Furthermore, according to an aspect, features of the present disclosure are practiced in an electrical circuit comprising discrete electronic elements, packaged or integrated electronic chips containing logic gates, a circuit utilizing a microprocessor, or on a single chip containing electronic elements or microprocessors. According to an aspect, features of the disclosure are practiced using other technologies capable of performing logical operations such as, for example, AND, OR, and NOT, including but not limited to mechanical, optical, fluidic, and quantum technologies. According to an aspect, features of the disclosure are practiced within a general purpose computer or in any other circuits or systems.

Aspects of the present disclosure, for example, are implemented as a computer process (method), a computing system, or as an article of manufacture, such as a computer program product or computer readable media. The computer program product may be a computer storage media readable by a computer system and encoding a computer program of instructions for executing a computer process. Accordingly, the aspects of the present disclosure may be embodied in hardware and/or in software (including firmware, resident software, micro-code, etc.). In other words, aspects of the present disclosure may take the form of a computer program product on a computer-usable or computer-readable storage medium having computer-usable or computer-readable program code embodied in the medium for use by or in connection with an instruction execution system.

Although aspects of the present disclosure have been described as being associated with data stored in memory and other storage mediums, data is also storable on or readable from other types of computer-readable media, such as secondary storage devices, like hard disks, floppy disks, or a CD-ROM, or other forms of RAM or ROM. The term computer-readable storage medium refers only to devices and articles of manufacture that store data and/or computer-executable instructions readable by a computing device. Computer-readable storage media do not include communications media.

According to an aspect, features of the present disclosure are utilized in various distributed computing environments where tasks are performed by remote processing devices that are linked through a communications network.

The description and illustration of one or more aspects provided in this application are intended to provide a complete thorough and complete disclosure the full scope of the subject matter to those skilled in the art and not intended to limit or restrict the scope of the invention as claimed in any way. The aspects, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an aspect with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A circuit for improving accuracy and user interaction efficiency for modeling a contract; comprising:
a matching circuit, comprising:
a plurality of XNOR logic gate arrays, wherein each XNOR logic gate array of the first plurality of XNOR logic gate arrays accepting a bit from a first matching source and a bit from a second matching source; and
a matching AND logic gate array, accepting outputs from each XNOR logic gate array of the plurality of XNOR logic gate arrays to produce a match bit; and
wherein the first matching source includes a service term input into a contract model;
wherein the second matching source includes one or more criteria templates including a set of criteria associated with a service term;
wherein the system uses the match bit to determine whether at least one criteria template for the service term exists; and
when it is determined that at least one criteria template for the service term exists, the system selects a criteria template based on a priority order, and automatically populates a criteria section of a contract modeler graphical user interface with the set of criteria included in the criteria template to associate with the service term for building a contract model representative of the contract.

2. A computer-implemented method for improving accuracy and user interaction efficiency for modeling a contract, comprising:
reading historical reimbursement data generated by claim valuations, wherein the historical reimbursement data comprises service terms and sets of criteria utilized to satisfy the service terms during the claim valuations;
for a particular service term, performing a search for one or more sets of criteria associated with the service term;
automatically creating one or more criteria templates based on the one or more sets of criteria;
prioritizing the one or more criteria templates;
receiving an input of a service term for building a contract model;
performing a search for one or more criteria templates associated with the service term;
selecting a criteria template from the one or more criteria templates based on a relevance of the set of criteria to an attribute; and
automatically populating a criteria section of a contract modeler graphical user interface with the set of criteria included in the selected criteria template to associate with the service term for building the contract model.

3. The computer-implemented method of claim 2, wherein receiving an input of a service term for building a contract model comprises receiving an input of a service term included in the contract.

4. The computer-implemented method of claim 3, wherein prior to reading historical reimbursement data generated by claim valuations:
valuating a claim; and
for each service term matched with a claim item based on a set of criteria, storing a record of the service term and the set of criteria.

5. The computer-implemented method of claim 4, further comprising:
determining a reimbursement amount for each claim item based on the matched service term; and
storing a record of the reimbursement amount.

6. The computer-implemented method of claim 5, wherein prioritizing the one or more criteria templates comprises comparing a reimbursement amount for the service term to prioritize the one or more criteria templates.

7. The computer-implemented method of claim 2, wherein prioritizing the one or more criteria templates comprises comparing a frequency of use of the criteria set for matching the service term with a claim item to prioritize the one or more criteria templates.

8. The computer-implemented method of claim 2, further comprising:
receiving a modification to the set of criteria automatically populated in the criteria section of the contract modeler graphical user interface; and
storing the modified set of criteria as a new criteria template associated with the service term.

9. The computer-implemented method of claim 2, wherein selecting a criteria template from the one or more criteria templates based on a relevance of the set of criteria to an attribute comprises selecting a criteria template based on a most frequently used criteria set for the service term.

10. The computer-implemented method of claim 9, wherein when more than one criteria template is associated with the service term, displaying the one or more other criteria templates in priority order, wherein a user is enabled to select one of the one or more other criteria templates for the service term in the contract model.

11. The computer-implemented method of claim 2, further comprising:
continuing to receive inputs of service terms for building the contract model until the contract is modeled;
storing the contract model;
valuating a claim using the contract model; and
storing a record of the valuation.

12. A system having improved functionality for improving accuracy and user interaction efficiency for modeling a contract, comprising:
a criteria template auto-generator operative to:
read historical reimbursement data generated by claim valuations, wherein the historical reimbursement data comprises service terms and sets of criteria utilized to satisfy the service terms during the claim valuations;
for a particular service term, perform a search for one or more sets of criteria associated with the service term;
automatically create one or more criteria templates based on the one or more sets of criteria; and
prioritize the one or more criteria templates;
a criteria template data store operative to store the one or more criteria templates;
a contract modeler operative to:
receive an input of a service term for building a contract model;
perform a search for one or more criteria templates associated with the service term;
select a criteria template from the one or more criteria templates based on a relevance of the set of criteria to an attribute; and
automatically populate a criteria section of a contract modeler graphical user interface with the set of criteria included in the selected criteria template to associate with the service term for building the contract model.

13. The system of claim 12, further comprising:
a claim valuator, wherein prior to reading historical reimbursement data generated by claim valuations, the claim valuator is operative to valuate a claim; and
a reimbursement data store operative to, for each service term matched with a claim item based on a set of criteria, store a record of the service term and the set of criteria.

14. The system of claim 13, wherein:
the claim valuator is further operative to determine a reimbursement amount for each claim item based on the matched service term; and
the reimbursement data store is further operative to store a record of the reimbursement amount.

15. The system of claim 12, wherein in prioritizing the one or more criteria templates, the criteria template auto-generator is further operative to compare a reimbursement amount for the service term to prioritize the one or more criteria templates.

16. The system of claim 12, wherein in prioritizing the one or more criteria templates, the criteria template auto-generator is further operative to compare a frequency of use of the criteria set for matching the service term with a claim item to prioritize the one or more criteria templates.

17. The system of claim 12, wherein:
the contract modeler is further operative to receive a modification to the set of criteria automatically populated in the criteria section of the contract modeler graphical user interface; and
the criteria template data store is further operative to store the modified set of criteria as a new criteria template associated with the service term.

18. The system of claim 12, wherein in selecting a criteria template from the one or more criteria templates based on a relevance of the set of criteria to an attribute, the contract modeler is operative to select a criteria template based on a most frequently used criteria set for the service term.

19. The system of claim 18, wherein when more than one criteria template is associated with the service term, the contract modeler is further operative to display the one or more other criteria templates in priority order, wherein a user is enabled to select one of the one or more other criteria templates for the service term in the contract model.

20. The system of claim 12, wherein:
the contract modeler is further operative to continue to receive inputs of service terms for building the contract model until the contract is modeled;
a contract model data store is operative to store the contract model;
the claim valuator is further operative to valuate a claim using the contract model; and
the reimbursement data store is further operative to store a record of the valuation.
